(19) United States
(12) Patent Application Publication
(10) Pub. No.: US 2020/0015612 A1
(43) Pub. Date: Jan. 16, 2020

(54) BIODEGRADABLE DRINKING STRAW

(71) Applicant: CHIEN-CHUNG HUANG, Taichung City (TW)

(72) Inventor: CHIEN-CHUNG HUANG, Taichung City (TW)

(21) Appl. No.: 16/036,616

(22) Filed: Jul. 16, 2018

(51) Int. Cl. A47G 21/18

(52) U.S. Cl. CPC A47G 21/18; B29C 47/0004

(57) ABSTRACT

A biodegradable drinking straw is made of plant fiber powder and at least one polymer. The at least one polymer is polylactide (PLA), polybutylene succinate (PBS), or polypropylene (PP). As an alternative of drinking straws made of traditional plastic materials, the biodegradable drinking straw when buried in landfills can be degraded by microorganisms and decay, eventually becoming a part of the nature again. Besides, the biodegradable drinking straw is made of neither non-petrochemical materials nor silica, so its production avoids excessively consuming the finite resources, thereby being contributive to energy conservation and environmental protection.

### BACKGROUND

### Technical Field

The present invention relates to drinking straws, and more particularly to a biodegradable drinking straw that contributes to environmental protection.

### Description of Related Art

Nowadays, drinking straws commercially available can be divided into three types by material, namely plastic, glass, and stainless steel.

Most existing plastic drinking straws are made of material extracted form petroleum. When used to consume high-temperature drinks, such a plastic drinking straw may release toxic components like plasticizer. Plastic drinking straws are also suspected to become a source of toxicity when contacting and being eroded by acidic drinks. Especially, organic juice bars where most drinks contain abundant fruit acids are more vulnerable to the potential toxicity of plastic drinking straws.

Glass drinking straws are made of silica (SiO₂) and other auxiliary components mixed in different proportions through different processes depending on their final applications. In manufacturing, glass drinking straws are formed at a temperature as high as 1600° C. and then cooked in an annealing furnace. However, the high brittleness makes glass drinking straws tends to accidentally break and cause production loss.

Stainless steel drinking straws are made with high energy consumption. Three of the four furnaces used in the manufacturing process have to be heated to about 1500° C. Although some modern factories have their own co-generation systems and/or waste heat recovery systems, there is still a considerable amount of waste gas and heat emitted to the environment. The fact that steel needs huge energy to perform transformation makes such a product unavoidably require high environmental costs.

From the perspective of manufacturing, both glass drinking straws and stainless steel drinking straws consume huge energy from material input to production. This energy consumption terribly exploits natural resources and aggravates the greenhouse effects. On the other hand, plastic drinking straws may contain a great quantity of plasticizer, which can be dissolved by and enter drinks of high temperature or containing esters. The human body may have difficulty in decomposing or excreting plasticizer it intakes. Like other plastic products, drinking straws containing plasticizer when come into long-term contact with children can induce precocious puberty and infertility and increase the risk of asthma and allergy, raising concerns about health and safety.

Hence, how to address the foregoing problems and shortcomings seen in the prior art is an issue for the inventor of the present invention and people in the relevant industries to work on.

### BRIEF SUMMARY OF THE INVENTION

The objective of the present invention is to provide a biodegradable drinking straw mainly made of a plant fiber powder and a polymer, which eliminates the use of traditional plastic materials in strew manufacturing and can be quickly biodegraded in the nature, thereby minimizing the consequent impact to the environment and supporting environmental protection.

Hence, the present invention provides a biodegradable drinking straw, which comprises:

a plant fiber powder; and

at least one polymer, being fused with the plant fiber powder and formed into a tubular body by means of extrusion molding.

Preferably, the at least one polymer comprises one polymer that is polylactide (PLA), polybutylene succinate (PBS), or polypropylene (PP).

Preferably, the at least one polymer comprises two polymers that are polylactide (PLA) and polybutylene succinate (PBS).

Preferably, the at least one polymer comprises two polymers that are polybutylene succinate (PBS) and polypropylene (PP).

Preferably, the at least one polymer comprises two polymers that are polylactide (PLA) and polypropylene (PP).

Preferably, the at least one polymer comprises three polymers that are polylactide (PLA), polybutylene succinate (PBS), and polypropylene (PP).

Preferably, the plant fiber powder is made of sugarcane fiber, bamboo fiber, coconut fiber, palm shell fiber, coffee grounds, wine dregs, wheat meal, cotton, hemp fiber, rice straw, rice husk, corn stalk, starch, or wood flour.

Preferably, the plant fiber powder is added in an amount of between 10% and 75%.

Preferably, the at least one polymer is added in an amount of between 10% and 90%.

Preferably, the plant fiber powder and the at least one polymer are fused at a temperature of between 120° C. and 180° C.

Preferably, the extrusion molding is performed at a temperature of between 140° C. and 230° C.

Preferably, the tubular body has a first end, a second end opposite to the first end, and a through hole passing through the first end and the second end.

The biodegradable drinking straw of the present invention is mainly composed of a plant fiber powder and at least one polymer. The at least one polymer may be polylactide (PLA), polybutylene succinate (PBS), or polypropylene (PP). As an alternative of drinking straws made of traditional plastic materials, the biodegradable drinking straw when buried in landfills can be degraded by microorganisms and decay, eventually becoming a part of the nature again. Besides, the biodegradable drinking straw is made of neither non-petrochemical materials nor silica, so its production avoids excessively consuming the finite resources, thereby being contributive to energy conservation and environmental protection.

The invention as well as a preferred mode of use, further objectives and advantages thereof will be best understood by reference to the following detailed description of illustrative embodiments when read in conjunction with the accompanying drawings.

### BRIEF DESCRIPTION OF THE SEVERAL VIEWS OF THE DRAWINGS

FIG. 1 is a perspective view of a biodegradable drinking straw according to one embodiment of the present invention.

FIG. 2 is an enlarged partial cross-sectional view of the biodegradable drinking straw in one aspect where it is composed of plant fiber powder and polylactide (PLA).

FIG. 3 is an enlarged partial cross-sectional view of the biodegradable drinking straw in another aspect where it is composed of plant fiber powder and polybutylene succinate (PBS).

FIG. 4 is an enlarged partial cross-sectional view of the biodegradable drinking straw in another aspect where it is composed of plant fiber powder and polypropylene (PP).

FIG. 5 is an enlarged partial cross-sectional view of the biodegradable drinking straw in another aspect where it is composed of plant fiber powder, polylactide (PLA), and polybutylene succinate (PBS).

FIG. 6 is an enlarged partial cross-sectional view of the biodegradable drinking straw in another aspect where it is composed of plant fiber powder, polylactide (PLA), and polypropylene (PP).

FIG. 7 is an enlarged partial cross-sectional view of the biodegradable drinking straw in still another aspect where it is composed of plant fiber powder, polybutylene succinate (PBS), and polypropylene (PP).

FIG. 8 is an enlarged partial cross-sectional view of the biodegradable drinking straw in yet another aspect where it is composed of plant fiber powder, polylactide (PLA), polybutylene succinate (PBS), and polypropylene (PP).

### DETAILED DESCRIPTION OF THE INVENTION

For further illustrating the means and functions by which the present invention achieves the certain objectives, the following description, in conjunction with the accompanying drawings and preferred embodiments, is set forth as below to illustrate the implement, structure, features and effects of the subject matter of the present invention.

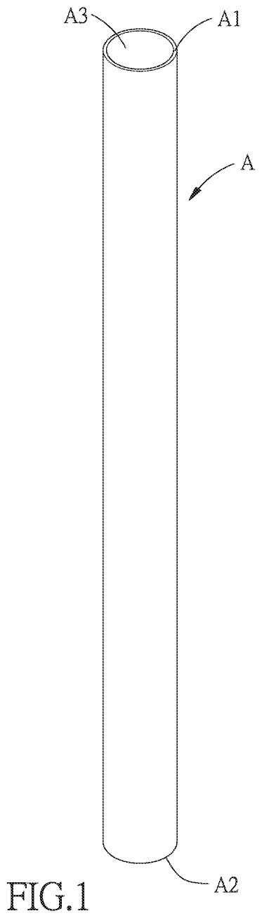

Referring to FIG. 1 through FIG. 8, the present invention embodiment provides a biodegradable drinking straw made of a plant fiber powder 10 and at least one polymer 20.

The plant fiber powder 10 may be sugarcane fiber, bamboo fiber, coconut fiber, palm shell fiber, coffee grounds, wine dregs, wheat meal, cotton, hemp fiber, rice straw, rice husk, corn stalk, starch, or wood flour. In the present embodiment, the plant fiber powder 10 is for example but not limited to sugarcane fiber. Particularly, the plant fiber powder 10 is added in an amount of between 10% and 75%.

The at least one polymer 20 is fused with the plant fiber powder 10 and formed into a tubular body A by means of extrusion molding before cooled and cured in water. Therein, the tubular body A is cut into the shape of the well-known drinking straw. In the present embodiment, the plant fiber powder 10 and the at least one polymer 20 are fused at a temperature of between 120° C. and 180° C. The extrusion molding is performed at a temperature of between 140° C. and 230° C. The tubular body A so made has a first end A1, a second end A2 opposite to the first end A1, and a through hole A3 passing through the first end A1 and the second end A2. Particularly, the at least one polymer 20 is added in an amount of between 10% and 90%. Thereby, the materials used herein can well substitute the traditional plastic materials, allowing the biodegradable drinking straw, after use, to be quickly biodegraded in the nature, so as to minimize its impact to the environment and make it favorable to environmental protection.

With the foregoing composition, the biodegradable drinking straw of the present invention may be realized in the following ways.

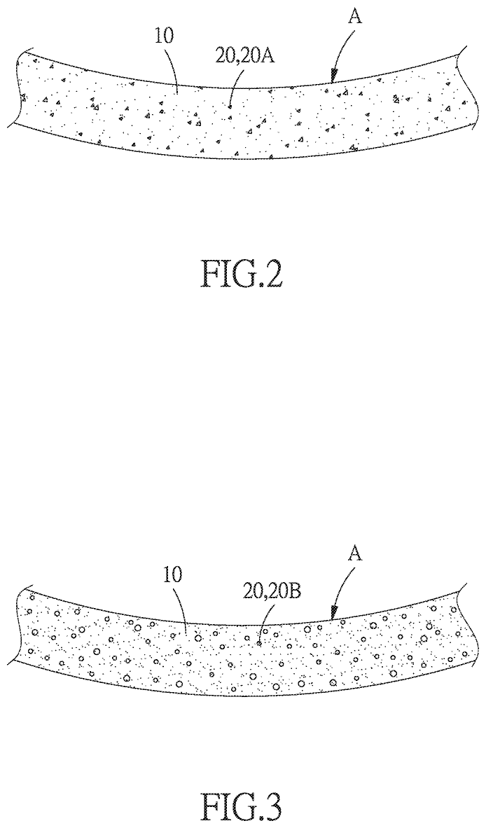

Referring to FIG. 2, the at least one polymer 20 comprises one polymer that is polylactide (PLA) 20A. In the drawing, the plant fiber powder 10 is indicated by dots, and the polylactide (PLA) 20A is indicated by the triangles. Since the plant fiber powder 10 is added in an amount of between 10% and 75%, the polymer 20 is added in an amount of between 10% and 90%. In implementation of the present embodiment, the plant fiber powder 10 is added in an amount of 33%, for example, and the polylactide (PLA) 20A is added in an amount of 67%, for example. However, the present is not limited to the present embodiment, and can alternatively be embodied by using the plant fiber powder 10 of 42% and the polylactide (PLA) 20A of 58%.

Referring to FIG. 3, the at least one polymer 20 comprises one polymer that is polybutylene succinate (PBS) 20B. In the drawing, the plant fiber powder 10 is indicated by dots, and the polybutylene succinate (PBS) 20B is indicated by the circles. Since the plant fiber powder 10 is added in an amount of between 10% and 75%, the polymer 20 is added in an amount of between 10% and 90%. In implementation of the present embodiment, the plant fiber powder 10 is added in an amount of 40%, for example, and the polybutylene succinate (PBS) 20B is added in an amount of 60%, for example. However, the present is not limited to the present embodiment, and can alternatively be embodied by using the plant fiber powder 10 of 28% and the polybutylene succinate (PBS) 20B of 72%.

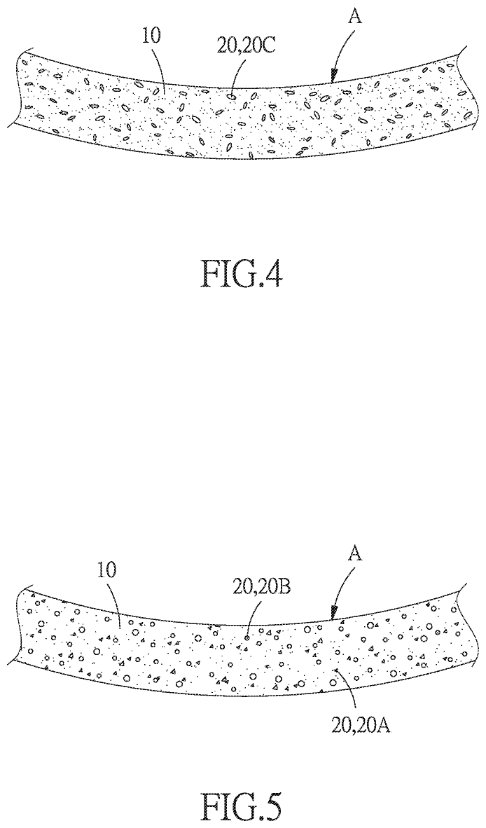

Referring to FIG. 4, the at least one polymer 20 comprises one polymer that is polypropylene (PP) 20C. In the drawing, the plant fiber powder 10 is indicated by dots, and the polypropylene (PP) 20C is indicated by ellipses. Since the plant fiber powder 10 is added in an amount of between 10% and 75%, the polymer 20 is added in an amount of between 10% and 90%. In implementation of the present embodiment, the plant fiber powder 10 is added in an amount of 45%, for example, and the polypropylene (PP) 20C is added in an amount of 55%, for example. However, the present is not limited to the present embodiment, and can alternatively be embodied by using the plant fiber powder 10 of 39%, and the polypropylene (PP) 20C of 61%.

Referring to FIG. 5, the at least one polymer 20 comprises two polymers. The first polymer is polylactide (PLA) 20A, indicated by the triangles. The second polymer 20 is polybutylene succinate (PBS) 20B, indicated by the circles. Since the plant fiber powder 10 is added in an amount of between 10% and 75%, the polymers 20 are jointly added in an amount of between 10% and 90%. In implementation of the present embodiment, the plant fiber powder 10 is added in an amount of 42%, for example, while the polylactide (PLA) 20A and the polybutylene succinate (PBS) 20B are added in amounts of 37% and 21%, respectively, for example. However, the present is not limited to the present embodiment, and can alternatively be embodied by using the plant fiber powder 10 of 45%, the polylactide (PLA) 20A of 20%, and the polybutylene succinate (PBS) 20B of 35%.

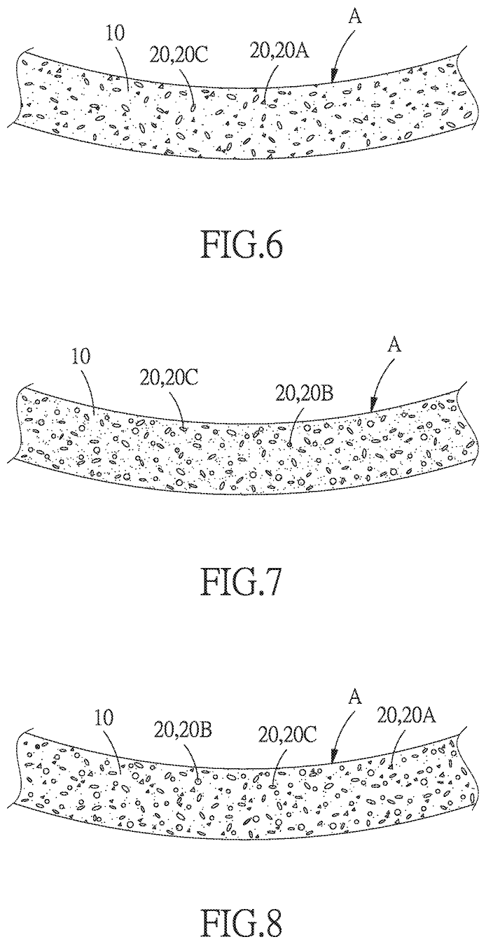

Referring to FIG. 6, the at least one polymer 20 comprises two polymers. The first is polylactide (PLA) 20A, indicated by the triangles. The second is polypropylene (PP) 20C, indicated by the ellipses. Since the plant fiber powder 10 is added in an amount of between 10% and 75%, the polymers 20 are jointly added in an amount of between 10% and 90%. In implementation of the present embodiment, the plant fiber powder 10 is added in an amount of 50%, for example, while the polylactide (PLA) 20A and the polypropylene (PP) 20C are added in amounts of 22% and 28%, respectively, for example. However, the present is not limited to the present embodiment, and can alternatively be embodied by using the plant fiber powder 10 of 50%, the polylactide (PLA) 20A of 36%, and the polypropylene 20C(PP) of 14%.

Referring to FIG. 7, the at least one polymer 20 comprises two polymers. The first polymer 20 is polypropylene (PP) 20C, indicated by ellipses. The second polymer 20 is polybutylene succinate (PBS) 20B, indicated by the circles. Since the plant fiber powder 10 is added in an amount of between 10% and 75%, the polymers 20 are jointly added in an amount of between 10% and 90%. In implementation of the present embodiment, the plant fiber powder 10 is added in an amount of 27%, for example, while the polybutylene succinate (PBS) 20B and the polypropylene 20C(PP) are added in amounts of 22% and 51%, respectively, for example. However, the present is not limited to the present embodiment, and can alternatively be embodied by using the plant fiber powder 10 of 50%, the polybutylene succinate (PBS) 20B of 36%, and the polypropylene 20C (PP) of 14%.

Referring to FIG. 8, the at least one polymer 20 comprises three polymers. The first polymer 20 is polylactide (PLA) 20A, indicated by the triangles. The second polymer 20 is polybutylene succinate (PBS) 20B, indicated by the circles. The third polymer 20 is polypropylene (PP) 20C, indicated by the ellipses. Since the plant fiber powder 10 is added in an amount of between 10% and 75%, the polymers 20 are jointly added in an amount of between 10% and 90%. In implementation of the present embodiment, the plant fiber powder 10 is added in an amount of 12%, for example, while the polylactide (PLA) 20A, the polybutylene succinate (PBS) 20B and the polypropylene 20C (PP) are added in amounts of 22%, 31%, and 35%, respectively, for example. However, the present is not limited to the present embodiment, and can alternatively be embodied by using the plant fiber powder 10 of 48%, the polylactide (PLA) 20A of 12%, the polybutylene succinate (PBS) 20B of 26%, and the polypropylene 20C (PP) of 14%.

With the understanding to the configuration of the present invention through the foregoing embodiments, the following description will be directed to the use and effects of the present invention.

The disclosed biodegradable drinking straw is mainly composed of the plant fiber powder 10 and the at least one polymer 20. The at least one polymer 20 may be polylactide (PLA) 20A, polybutylene succinate (PBS) 20B, or polypropylene (PP) 20C. As an alternative of drinking straws made of traditional plastic materials, the biodegradable drinking straw when buried in landfills can be degraded by microorganisms and decay, eventually becoming a part of the nature again. Besides, the biodegradable drinking straw is made of neither non-petrochemical materials nor silica, so its production avoids excessively consuming the finite resources, thereby being contributive to energy conservation and environmental protection. The biodegradable drinking straw, after use, can be fully and naturally biodegraded, minimizing its impact to the environment, and addressing the concerns about healthy risks and environmental pollution as coming with the use of traditional drinking straws.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A biodegradable drinking straw, comprising:
a plant fiber powder; and at least one polymer, being fused with the plant fiber powder and formed into a tubular body by means of extrusion molding.

2. The biodegradable drinking straw of claim 1, wherein the at least one polymer comprises one polymer that is polylactide (PLA), polybutylene succinate (PBS), or polypropylene (PP).

3. The biodegradable drinking straw of claim 1, wherein the at least one polymer comprises two polymers that are polylactide (PLA) and polybutylene succinate (PBS); polybutylene succinate (PBS) and polypropylene (PP); or polylactide (PLA) and polypropylene (PP).

4. The biodegradable drinking straw of claim 1, wherein the at least one polymer comprises three polymers that are polylactide (PLA), polybutylene succinate (PBS), and polypropylene (PP).

5. The biodegradable drinking straw of claim 1, wherein the plant fiber powder is made of sugarcane fiber, bamboo fiber, coconut fiber, palm shell fiber, coffee grounds, wine dregs, wheat meal, cotton, hemp fiber, rice straw, rice husk, corn stalk, starch, or wood flour.

6. The biodegradable drinking straw of claim 1, wherein the plant fiber powder is added in an amount of between 10% and 75%.

7. The biodegradable drinking straw of claim 1, wherein the at least one polymer is added in an amount of between 10% and 90%.

8. The biodegradable drinking straw of claim 1, wherein the plant fiber powder and the at least one polymer are fused at a temperature of between 120° C. and 180° C.

9. The biodegradable drinking straw of claim 1, wherein the extrusion molding is performed at a temperature of between 140° C. and 230° C.

10. The biodegradable drinking straw of claim 1, wherein the tubular body has a first end, a second end opposite to the first end, and a through hole passing through the first end and the second end.
